(19) United States
(12) Patent Application Publication
(10) Pub. No.: US 2025/0340256 A1
(43) Pub. Date: Nov. 6, 2025

(54) FIFTH WHEEL LOCKING MECHANISM WEAR RATE MEASUREMENT METHOD

(71) Applicants: SAMPA OTOMOTIV SANAYI VE TICARET ANONIM SIRKETI, Samsun (TR); SAMPA CAMP TEKNOLOJI ANONIM SIRKETI, Istanbul (TR)

(72) Inventors: Arda KOSEOGLU, Samsun (TR); Erdem SAHINKAYA, Samsun (TR); Nurettin Husnu CEP, Samsun (TR); Ismail Utku ALBAYRAK, Samsun (TR); Sercan EKILI, Samsun (TR); Kagan YOLCU, Samsun (TR)

(73) Assignees: SAMPA OTOMOTIV SANAYI VE TICARET ANONIM SIRKETI, Samsun (TR); SAMPA CAMP TEKNOLOJI ANONIM SIRKETI, Istanbul (TR)

(21) Appl. No.: 19/144,783

(22) PCT Filed: Dec. 27, 2023
(86) PCT No.: PCT/TR2023/051721

§ 371 Date: Jun. 30, 2025

(30) Foreign Application Priority Data
Dec. 30, 2022 (TR) 2022/021634

(51) Int. Cl. B62D 53/08

(52) U.S. Cl. CPC B62D 53/0885

(57) ABSTRACT

The present invention relates to a method of measuring the wear of a fifth wheel locking mechanism, which, in existing fifth wheel systems, enables the service life of the fifth wheel to be increased by automatically measuring the amount of wear and transferring it to the user.

The present invention relates to an existing fifth wheel system which adjusts the locking tightness by means of an automatically movable actuator, by automatically measuring the amount of wear of the locking mechanism and informs the user, thereby increasing the service life of the fifth wheel.

Fifth wheel systems provide the connection between the trailer and the towing part of the vehicle. There is a kingpin mounted on the trailer to enable the connection. The fifth wheel and kingpin are connected by bringing the trailer and truck aligns to each other. During the connection, the parts on the locking mechanism move and the fifth wheel and kingpin are locked. The fifth wheel is locked by triggering the spring which is in the stretched position by pulling the fifth wheel lever. Since the locking mechanism is locked tightly with the force from the spring and causes premature wear, it is necessary to adjust the tightness of the locking mechanism after each fifth wheel and king pin locking process. The adjustment of the locking mechanism tightness can be performed manually by the operator by means of an adjuster or automatically by means of an automatically movable activator. In systems where the locking tightness is adjusted manually by the operator, wear information can be detected by mechanical means such as the noisy operation of the kingpin during riding or by sensors placed on the locking parts in the fifth wheel. In systems where the locking tightness is adjusted automatically, wear information cannot be determined. Since wear information cannot be determined, the user is unable to recognize when the wear parts are due for replacement and maintenance. For this reason, the user cannot ensure that the wear parts are replaced at the predetermined time and the service life of the fifth wheel is reduced.

The Turkish patent document TR2022005578 relates to the automatic movement of the adjustment element that adjust the locking tightness of the fifth wheel in the state of the art. The document does not disclose a system that conveys information about the wear of the fifth wheel to the user. Therefore, the user cannot predict the timing for tasks such as replacement and maintenance of worn parts on the fifth wheel. Since worn parts can also cause damage to other components, it results in additional costs. Moreover, the inability to observe the wear of these parts poses a risk to the safety of the vehicle.

The American patent document US20200262256A1 relates to the measurement of fifth wheel wear information by means of sensors which is placed on fifth wheel lever and capable of detecting a magnetic field. However, due to the measurement of wear from a movable part such as the arm in this document, precise measurements cannot be achieved. Additionally, the magnet used during measurement may produce inaccurate data when it reaches the center of the sensors or when the sensors are very close to each other, affecting the magnetic field. The use of multiple sensors in this patent not only increases the cost but also requires the user to step out from the cabin and check the fifth wheel to learn about the wear information.

In the prior art American patent document U.S. Pat. No. 10,926,816B2 relates to the measurement of vibrations of the fifth wheel lock mechanism using a sensor positioned on the lock mechanism to calculate the amount of wear. In the mentioned system, when the vehicle encounters rough roads such as potholes and gravel, the vibrations generated can disrupt the sensors that are intended to provide wear information, leading to inaccurate measurements. Since the system aims to measure wear information from the vibration characteristics, sensors are placed in areas near the kingpin where vibrations are most intense, resulting in a reduced life for the sensors. Additionally, the presence of multiple sensors in this system and the low lifespan of the sensors cause to increased costs.

The European patent document EP3877243B1 relates to a wear sensor capable of measuring the material thickness of the fifth wheel coupling plate, especially on the surface facing the trailer. In this document, manual adjustment is performed via fifth wheel lever, and accuracy is low due to the large distance between plates in the adjustment area. Therefore, wear information cannot be conveyed to the user accurately in this system.

The objective of the invention is to create a system that informs the user about the replacement time of the spare parts of the fifth wheel at the right time by automatically measuring the amount of wear in the fifth wheel systems having an adjusting element that can automatically move and adjust, and thus increasing the service life.

A fifth wheel as defined in the first claim and the other claims of the present invention, used in a fifth wheel system for heavy commercial type vehicles, comprising at least one lever for removing the kingpin from the locked position, at least one moving part connected with the lever, and at least one sensor for detecting the displacement of the moving part, at least one jaw for locking the kingpin, at least one wedge for adjusting the locking tightness of the jaw and at least one actuator for adjusting the tightness of the locking by moving the wedge, at least one activator for actuating the actuator and at least one electronic circuit for automatically moving the actuator.

The fifth wheel of the invention comprises an electronic circuit for calculating wear information in systems having an automatically movable actuator, and a method of operation of this calculation.

In fifth wheel systems with an adjustment element that can automatically adjust the tightness of the locking by providing the movement of the wedge, wear information cannot be determined. Since the wear information cannot be determined by the user, the replacement times of the worn parts on the fifth wheel cannot be tracked. For this reason, the service life of the fifth wheel is shortened. In addition, since the wearing parts on the fifth wheel have certain wear limits, when used outside these limits, it will also cause problems for the safety of the vehicle.

The fifth wheel has an electronic circuit that can automatically calculate and transmit wear information to the user, solving the aforementioned problems of reduced safety of the vehicle connection and reduced lifetime of the fifth wheel.

In order to calculate the wear information of the fifth wheel, the time calculated during calibration is compared with the calculated forward travel time in normal use. During the calibration process, a reference point is defined to the system. After the reference point is defined, the adjuster is brought into contact with the wedge more than once by the forward and backward movement of the adjuster. After the actuator contacts the wedge, it returns back to the reference point. Thus, the position of the actuator is brought to the reference point. After the defined reference point is saved in the processor's memory, the wear rate of the fifth wheel can be calculated.

A method of calculating the wear rate of the locking mechanism of the fifth wheel system including an automatically movable adjuster;
a) The sensor detects the movement of the moving part by touching or not touching the moving parts on the fifth wheel and transmits the information that the fifth wheel is locked state to the electronic card. After receiving the information that the fifth wheel is locked on the electronic card, the time counter is started.
b) The processor on the electronic board sends a command to the actuator to move after starting the time counter. Thus, the actuator starts moving towards the wedge.
c) After the actuator contacts the wedge with the torque transmitted from the motor, the motor draws high current to move the wedge. Since the values read on the electronic card change with the change in the current value, it is understood that the actuator rests on the wedge. When the adjusting screw contacts the wedge, the electronic board calculates the time until the adjusting screw rests on the wedge. After the adjusting screw rests on the wedge, it is moved towards the wedge for the time previously defined in the processor's memory in order to set the optimum value of the locking tightness. This is the time the motor needs to rotate in order to optimize the locking tightness. In the literature, the optimum value of the locking tightness is achieved manually by turning the adjusting screw 1.5 turns. However, this time can change when factors such as the screw pitch or screw diameter of the adjusting screw change. Finally, the electronic board adds these times together to calculate the total time and save it in the processor's memory.
d) The electronic board calculates the wear rate by comparing the time the adjusting screw moves until it rests against the wedge with the time calculated during the calibration process.

The formula used in the calculation;

$$\frac{\vert T 4 - T 1 \vert}{T 4} \times 100 = \% Amount of wear is determined .$$

The maximum value of the difference between the travel time of the actuator from the reference point until it contacts the wedge and the travel time of the adjusting screw until it contacts the wedge in automatic operation mode while the vehicle is running is calculated during calibration. Laboratory and vehicle tests carried out while calculating this value, a kingpin and fifth wheel with the maximum level of wear permitted by the ECE R55 regulation were first used. Here, the position of the adjusting screw at the point where it rests on the wedge is taken as the reference point. This reference point also indicates the maximum level of wear of the fifth wheel system and, in normal use, the system is considered fully worn when the wedge reaches this point. Then, using a fifth wheel and kingpin that has never been worn or used, the maximum time until the fifth wheel wears out is calculated by measuring the time from the reference point of the adjusting screw to the wedge. These times may vary depending on the diameter of the adjusting screw, screw pitch or motor power.
e) After the calculation, the wear information is transferred to the display device in the cabin and/or to the mobile application. The electronic card that enables the adjustment screw to move, controls the motor and receives the information from the processor. By transferring the wear information to the user, it is understood that the maintenance, repair and replacement periods of the worn parts on the fifth wheel are due. In this way, risks due to wear are minimized and the lifetime of the fifth wheel is increased.

In one embodiment of the invention, in a method of measuring the amount of wear of a fifth wheel system having an automatically movable adjusting screw, when the kingpin and the fifth wheel are separated, the sensor located on any of the moving parts transmits information to the electronic circuit that the fifth wheel is opened. After the information that the fifth wheel system has been opened is transmitted to the electronic circuit, the time information saved in the processor's memory is used to send a command to the activator to move backward by this time.

When the total time taken to move against the wedge with the command sent from the electronic board to the actuator is equal to the total time taken by the adjusting screw to move towards the wedge, the electronic board transmits the stop command to the actuator and the adjusting screw is stopped. In this way, each time the fifth wheel is opened, the adjusting bolt can return to its reference point.

With the adjustment screw returning to the reference point, the wear information is transmitted to the user accurately.

In one embodiment of the invention, the amount of wear of the fifth wheel system is transferred to the user in a wired and/or wireless manner via Bluetooth, WLAN, radio networks and/or a mobile application. The wear rate can also be transferred to the user by sending a sound, warning and/or light signal from the fifth wheel itself. Thanks to the automatic transfer of wear information to the user, the amount of wear can be monitored from the cabin. This reduces the potential risks and safety issues that may arise due to wear on the fifth wheel system.

The inventive fifth wheel has a wear measurement method that enables the wear information to be automatically transferred to the user, thereby increasing the service life of the fifth wheel by detecting faults that may occur due to wear in advance.

The fifth wheel wear measurement method for achieving the object of the present invention is shown in the accompanying figures, and from these figures:

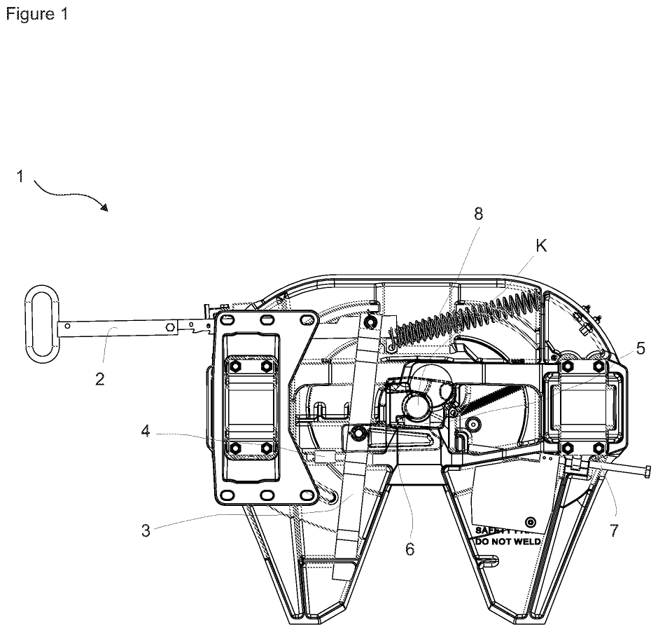

FIG. 1—Bottom view of the fifth wheel in the state of the art.

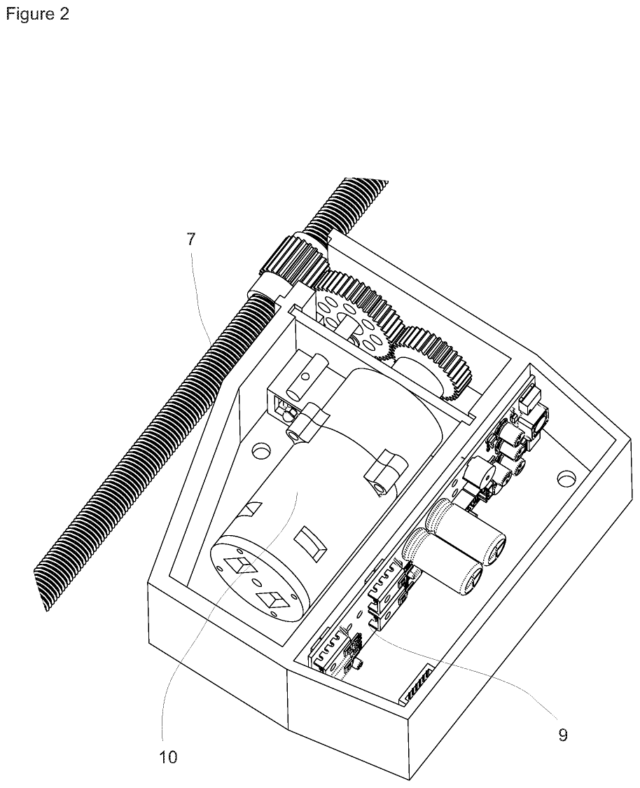

FIG. 2—Perspective view of the automatically movable actuator mounted on the fifth wheel in the state of the art.

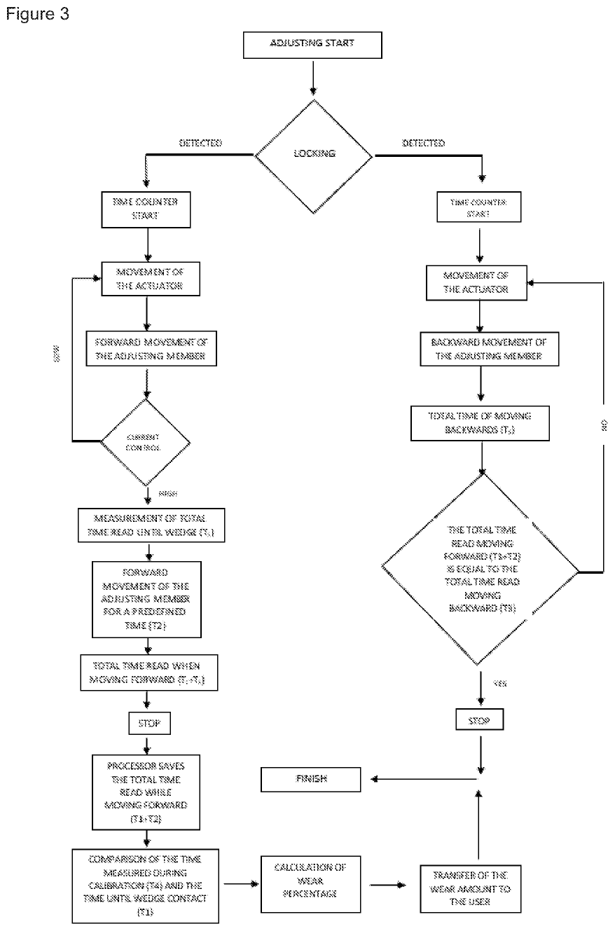

FIG. 3—Diagram view of the inventive fifth wheel wear measurement method.

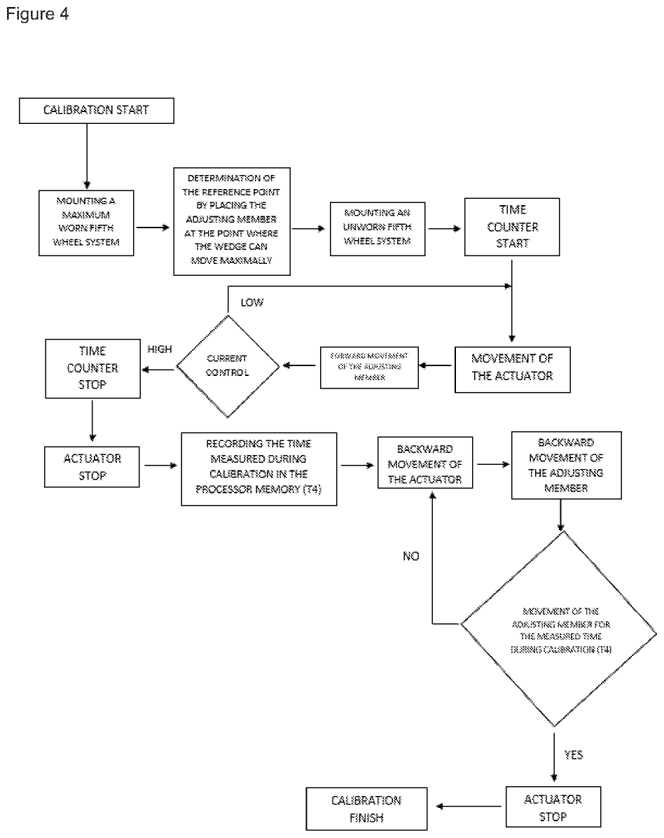

FIG. 4—Diagram view of the inventive fifth wheel wear measurement method during the calibration process.

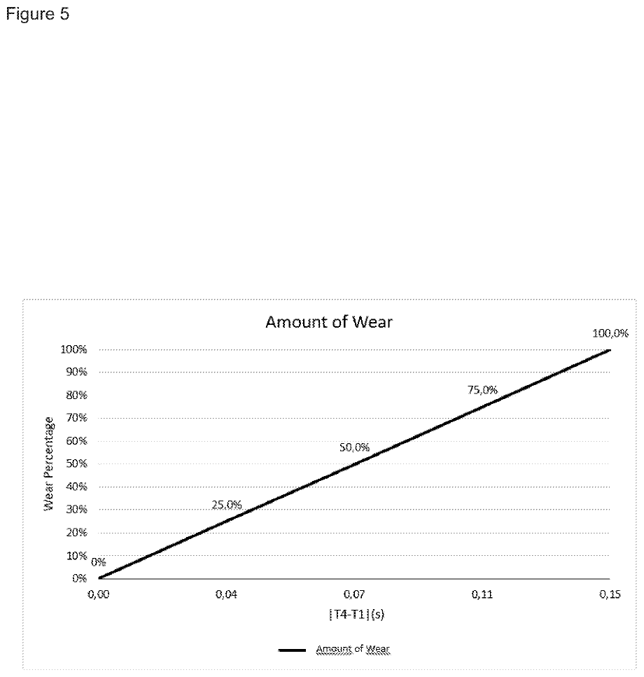

FIG. 5—Time dependent graph of the amount of wear of the fifth wheel.

The parts in the figures are numbered and the corresponding numbers are given below.
1 Fifth wheel
2 Lever
3 Moving part
4 Sensor
5 Jaw
6 Wedge
7 Adjusting member
8 Spring
9 Electronic circuit
10 Actuator
K Kingpin
T₁ Time for adjusting member moves until it contacts the wedge
T₂ Pre-defined time
T₃ Total time the adjusting member moves in the opposite direction of the wedge
T₄ Time measured during calibration

Fifth wheel (1), at least one lever (2) for removing the kingpin (K) from the locked position, at least one moving part (3) in connection with the lever (2), at least one sensor (4) for detecting the displacement of the moving part (3), at least one jaw (5) for locking the kingpin (K), at least one wedge (6) for adjusting the locking tightness of the jaw (5) and at least one adjusting member (7) for adjusting the locking tightness by moving the wedge (6), at least one actuator (10) for driving the adjusting member (7) and an electronic circuit (9) for automatically moving the adjusting member (7) (FIG. 1 and FIG. 2).

The electronic circuit (9) on the fifth wheel (1) also includes a processor, motor driver, bluetooth module, display device, current control sensor, voltage sensor and temperature sensor for internal temperature measurement (FIG. 2).

The fifth wheel (1) is locked by the triggering of the spring (8), which is in tensioned state by pulling the lever (2). After the locking process, wear occurs on these components due to the movement of the vehicle or the contact of the components on the fifth wheel (1) system with each other over time. In order to minimize wear, the electronic circuit (9) activates the actuator (10) after the locked signal received from the sensor (4) on the moving part (3). Thus, the adjusting member (7) automatically moves towards the wedge (6) and the optimum value of the locking tightness is adjusted. After the adjusting member (7) moves towards the wedge (6), wear occurs on the components of the fifth wheel (1) even if the optimum value of the locking tightness is set. Since the worn parts on the fifth wheel (1) need to be replaced, the user needs to know the wear information in advance (FIG. 1 and FIG. 2).

In order to know the wear information of the fifth wheel (1), it is formulated by comparing the time measured during calibration (T4) with the forward wheel time measured in automatic mode (T1).

Since the automatic mode is operated after the calibration process, the calibration process defines the reference point information to the processor before the lock mode starts automatically. This allows the processor to calculate the amount of wear by comparing the wheel time (T1) with the time calculated during calibration (T4). Once the reference point is defined, the adjusting member (7) moves towards the wedge (6), contacts the wedge (6) and then returns to the reference point (FIG. 1 and FIG. 4).

Method for measuring the wear rate of a fifth wheel (1) system comprising an automatically movable adjusting member (7);
a) The sensor (4) that detects the magnetic field emitted from the switch such as magnet on the moving part (3) transmits the information to the electronic circuit (9) that the fifth wheel (1) is locked. The electronic circuit (9) starts the time counter after receiving the information that the fifth wheel (1) is locked (FIG. 1-FIG. 3).
b) After the electronic circuit (9) starts the time counter, it sends the command to the actuator (10) to move. Thus, the adjusting member (7) starts to move towards the wedge (6) (FIG. 1-FIG. 3).
c) With the movement transferred from the actuator (10), the actuator (10) draws high current after the adjusting member (7) contacts the wedge (6). Since the current value read on the electronic circuit (9) changes due to the high current drawn, it is perceived that the adjusting member (7) contacts the wedge (6). At the point where the adjusting member (7) contacts the wedge (6), the electronic circuit (9) calculates the time (T1) until the adjusting member (7) contacts the wedge (6). Furthermore, after the adjusting member (7) contacts the wedge (6), it is moved towards the wedge (6) for a predefined time (T2). Here, the electronic circuit (9) calculates and memorizes the total time (T1+T2) read while moving forward (FIG. 1-FIG. 3).
d) The amount of wear is calculated by comparing the travel time (T1) calculated by the electronic circuit (9) when the adjusting member (7) contacts the wedge (6) with the time (T4) calculated during the calibration process. The formula used for the calculation is;

$$\frac{\vert T 4 - T 1 \vert}{T 4} \times 100 = \% Amount of wear is determined ( FIG . 1 - FIG . 5 ) .$$

In the formula, the difference between the time (T4) calculated during the calibration process and the time (T1) during normal use when the adjusting member (7) moves until it contacts the wedge (6) is a maximum of 0.15 seconds. To calculate this value, a fifth wheel (1) and kingpin (K) that were maximally worn during calibration were used, where the position of the adjusting member (7) when the adjusting member (7) contacts the wedge (6) was taken as the reference point. This reference point also indicates the maximum wear level of the fifth wheel (1) system and, in normal use, the wedge (6) is considered fully worn when it reaches this point. Then, using an unworn fifth wheel (1) and kingpin (K), the time (T4) from the reference point of the adjusting member (7) to contact with the wedge (6) was calculated. Since the difference between these values is 0.15 seconds, the maximum time until the fifth wheel (1) wears out is assumed to be 0.15 seconds (FIG. 1 and FIG. 4).
e) After the calculation, the wear information data is transferred to the display device in the user cabin and to the mobile application via bluetooth module. The electronic circuit (9), which allows the adjusting member (7) to move, controls the actuator (10) and receives the information from the processor. In this way, the wear information is transferred to the user and it can be understood that the maintenance, repair and replacement periods of the parts on the fifth wheel (1) are approaching (FIG. 1, FIG. 2, FIG. 3 and FIG. 5).

In an embodiment of the invention, a method of measuring the wear rate of a fifth wheel (1) system having an automatically movable adjusting member (7), When the kingpin (K) disengages from the fifth wheel (1), the information received from the sensor (4) on the moving part (3) that the fifth wheel (1) has been opened is transmitted to the electronic circuit (9) and a reverse command is sent to the actuator (10) by using the total forward travel time (T1+T2) saved in the memory of the processor on the electronic circuit (9) (FIG. 1-FIG. 3).

With the command sent from the electronic circuit (9), the electronic circuit (9) detects the position where the wedge (6) will stop when the total time (T3) read while moving in the opposite direction is equal to the total time (T1+T2) read while moving towards the wedge (6). In this case, the electronic circuit (9) transfers the stop command to the actuator (10) and the movement of the adjusting member (7) is stopped. In this way, every time the fifth wheel (1) is turned on, the adjusting member (7) returns to its reference point so that the wear information can be transferred to the user accurately (FIG. 1-FIG. 3).

In one embodiment of the invention, the fifth wheel (1) wear information is transferred to the user in a wired and/or wireless manner using Bluetooth, WLAN or radio networks. By means of this application, which is capable of transferring a wear data, the user can automatically observe that the fifth wheel (1) locking mechanism is worn. By transferring the wear data to the user, potential risks due to wear on the fifth wheel (1) locking mechanism is prevented (FIG. 1, FIG. 3 and FIG. 5).

The present invention provides a method for measuring wear in fifth wheel (1) systems having an adjusting member (7) that can automatically move and adjust the fifth wheel (1) by automatically transferring the wear rate to the user, thereby preventing errors that may occur due to wear and increasing the service life of the fifth wheel (1).

1. A method for measuring an amount of wear of a fifth wheel system including an automatically moving adjusting member in heavy commercial type vehicles, comprising:
a) an electronic circuit starting a time counter upon receiving information from a sensor, which detects the movement of a movable part, indicating that a fifth wheel is in a locked state,
b) when an actuator starts to move, an adjusting member starting to move towards a wedge,
c) when the adjusting member comes into contact with the wedge, the electronic circuit reading a time (T1) of the movement of the adjusting member until the adjusting member touches the wedge by monitoring a change in a measured current on the electronic circuit,
d) comparing the time (T1) with a pre-determined time during calibration (T4) to calculate a amount of wear, and
c) transferring wear information associated with the calculated amount of wear to be made available to a user.

2. A method for measuring the amount of wear of the fifth wheel system as in claim 1, wherein a total time (T3) for which the adjusting member moves when moving backwards is equal to a total time (T1+T2) read when moving forwards.

3. A method for measuring the amount of wear of the fifth wheel system as in claim 1, wherein the wear information is transferred in a wired and/or wireless manner.
